(19) United States
(12) Patent Application Publication
(10) Pub. No.: US 2009/0087689 A1
(43) Pub. Date: Apr. 2, 2009

(54) MAGNETIC RECORDING MEDIUM

(76) Inventors: Hiroaki Doushita, Kanagawa (JP); Masahito Oyanagi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 12/240,284

(22) Filed: Sep. 29, 2008

(30) Foreign Application Priority Data
Sep. 28, 2007 (JP) 2007-256647

(51) Int. Cl. G11B 5/706

(52) U.S. Cl. 428/844.8

(57) ABSTRACT

The magnetic recording medium comprises a magnetic layer comprising a ferromagnetic powder and a binder on a nonmagnetic support. In the magnetic recording medium, a number of protrusions equal to or greater than 10 nm in height on the magnetic layer surface, as measured by an atomic force microscope, ranges from 50 to 500/1,600 μm², the binder comprises a polyurethane resin with a weight average molecular weight ranging from 100,000 to 200,000, and the magnetic layer further comprises a carbonic ester having a molecular weight ranging from 360 to 460.

### CROSS-REFERENCE TO RELATED APPLICATIONS

This application claims the benefit of priority under 35 USC 119 to Japanese Patent Application No. 2007-256647 filed on Sep. 28, 2007, which is expressly incorporated herein by reference in its entirety.

### BACKGROUND OF THE INVENTION

1. Field of the Invention

The present invention relates to a magnetic recording medium, and more particularly, to a magnetic recording medium for high-density recording that is stable during high-speed running and affords good storage properties.

2. Discussion of the Background

Particulate magnetic recording media are known. In a particulate magnetic recording medium, a magnetic coating material, prepared by kneading and dispersing a ferromagnetic powder, binder, and various additives with an organic solvent, is coated on a nonmagnetic support and dried to form a magnetic layer. To achieve high recording densities in magnetic recording media, microparticulate ferromagnetic metal powder, hexagonal ferrite powder, and the like have come to be employed as the ferromagnetic powder. Particulate magnetic recording media employing such microparticulate ferromagnetic powders have been employed in computer recording media, such as computer backup data cartridges, to achieve striking improvement in characteristics.

To enhance electromagnetic characteristics in particulate magnetic recording media, it is important to employ a ferromagnetic powder having optimal magnetic characteristics for the recording and reproduction device, smooth the surface of the medium to minimize spacing loss, and reduce output loss due to recording demagnetization. For example, Japanese Unexamined Patent Publication (KOKAI) No. 2005-71537 or English language family member US 2005/0048324 A1 proposes that surface microprotrusions be kept below a certain level to inhibit surface spacing loss. The contents of these applications are expressly incorporated herein by reference in their entirety.

However, when the smoothness of the surface of the magnetic layer is increased, a problem is encountered in the form of reduced running property due to an increase in the frictional coefficient. Accordingly, lubricant is widely added to the magnetic layer and nonmagnetic layer in an attempt to lower the frictional coefficient. Such attempt is disclosed in, for example, Japanese Unexamined Patent Publication (KOKAI) Heisei No. 8-77547 or English language family member U.S. Pat. No. 5,560,983, which are expressly incorporated herein by reference in their entirety.

However, investigation by the present inventors has revealed that in magnetic recording media having a high degree of surface smoothness, even when the addition of lubricant ensures good running property, the tape sticks to the head, compromising running during renewed running, when the tape and head are left in contact following running. This phenomenon is thought to occur due to reduction in surface protrusions due to of high-speed running and meniscus force of fluid lubricant present on the surface. That is, when the protrusions on the tape surface decrease to below the thickness of the fluid lubricant, and the surface tension due to the fluid lubricant acting between the tape and the magnetic head increases markedly, it is thought that this causes the tape to stick to the head. As a countermeasure, it is possible to attempt to reduce the surface tension by reducing the amount of fluid lubricant on the tape surface, but the reduction in fluid lubricant causes an accelerated increase in the frictional coefficient during high-speed running, making it difficult to achieve repeat running stability.

### SUMMARY OF THE INVENTION

An aspect of the present invention provides for a magnetic recording medium affording both high-speed running stability and good storage properties.

The present inventors conducted extensive research into achieving the above-stated magnetic recording medium, resulting in the following discoveries.

Sticking between the tape and head during storage can be inhibited using a carbonic ester-based lubricant capable of ensuring lubrication properties even when the quantity present on the surface is relatively small. Further, the use of a high molecular weight urethane binder in the magnetic layer can inhibit migration of low molecular weight components of the binder onto the surface, inhibit binder flow due to repeat running, and inhibit an increase in frictional force during high-speed running. Thus, in a magnetic recording medium in which the number of protrusions on the magnetic layer has been controlled to reduce the spacing loss, the increase in frictional force can be inhibited during high-speed running and sticking of the tape and head can be suppressed during storage.

The present invention was devised based on the above discoveries.

An aspect of the present invention relates to a magnetic recording medium comprising a magnetic layer comprising a ferromagnetic powder and a binder on a nonmagnetic support, wherein

a number of protrusions equal to or greater than 10 nm in height on the magnetic layer surface, as measured by an atomic force microscope, ranges from 50 to 500/1,600 μm²,

the binder comprises a polyurethane resin with a weight average molecular weight ranging from 100,000 to 200,000, and

the magnetic layer further comprises a carbonic ester having a molecular weight ranging from 360 to 460.

The carbonic ester may be a carbonic ester denoted by general formula (1).

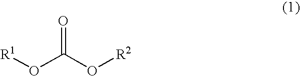

[In general formula (1), R¹ and R² each independently denote a saturated hydrocarbon group.]

In general formula (1), one of R¹ and R² may denote a saturated hydrocarbon group having a branched structure. The branched structure may be present at a position in the saturated hydrocarbon group.

In general formula (1), among R¹ and R², one may denote a saturated hydrocarbon group having a branched structure and the other may denote a saturated hydrocarbon group having a linear structure.

The saturated hydrocarbon group having a branched structure may be 2-methylpropyl group, 2-methylbutyl group or 2-ethylhexyl group.

The polyurethane resin may comprise the following polyurethane resin (A) and/or the following polyurethane resin (B).

Polyurethane resin (A): A polyurethane resin with a weight average molecular weight ranging from 100,000 to 200,000 in the form of a reaction product of a polyether polyol; a short-chain diol having a bridged hydrocarbon structure denoted by the following (a) and/or a bridged hydrocarbon structure denoted by the following (b); and an organic diisocyanate.

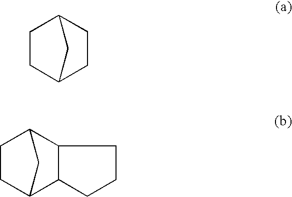

Polyurethane resin (B): A polyurethane resin with a weight average molecular weight ranging from 100,000 to 200,000 in the form of a reaction product of a polyester polyol having a weight average molecular weight ranging from 100,000 to 200,000, comprising an aliphatic dibasic acid and an aliphatic diol not having a cyclic structure but comprising a branched alkyl side chain; an aliphatic diol having a branched alkyl side chain with a total carbon number of equal to or more than 3; and an organic diisocyanate.

The present invention can provide a magnetic recording medium, having good surface smoothness and good running stability, that is capable of renewed running without undergoing running failure due to sticking after leaving the medium and the head in a state of contact following running.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

The present invention relates to a magnetic recording medium comprising a magnetic layer comprising a ferromagnetic powder and a binder on a nonmagnetic support. In the magnetic recording medium of the present invention, a number of protrusions equal to or greater than 10 nm in height on the magnetic layer surface, as measured by an atomic force microscope, ranges from 50 to 500/1,600 μm², the binder comprises a polyurethane resin with a weight average molecular weight ranging from 100,000 to 200,000, and the magnetic layer further comprises a carbonic ester having a molecular weight ranging from 360 to 460.

The magnetic recording medium of the present invention will be described in greater detail below.

### Number of Protrusions on the Surface of the Magnetic Layer

In the magnetic recording medium of the present invention, the number of protrusions equal to or greater than 10 nm in height on the magnetic layer surface, as measured by an atomic force microscope (AFM), ranges from 50 to 500/1,600 μm². When the surface of the magnetic layer is excessively smooth, the medium tends to stick to members, and the running properties become extremely unstable. By contrast, when a prescribed number of protrusions equal to or greater than 10 nm in height is present on the surface of the magnetic layer, the head and medium come into stable contact and good head contact is ensured. However, when an excessively large number of protrusions equal to or greater than 10 nm in height is present, the space between the medium and the head increases and output ends up dropping precipitously. In the present invention, the number of protrusions equal to or greater than 10 nm in height as measured by AFM on the surface of the magnetic layer is kept to within the above range, thereby permitting stable running and reducing the drop in output due to spacing loss. The number of protrusions is preferably 55 to 360/1,600 μm², more preferably 65 to 300/1,600 μm².

Various means can be employed to keep the number of protrusions equal to or greater than 10 nm in height on the surface of the magnetic layer within the above-stated range. For example, the number of aggregate particles of magnetic material potentially becoming protrusions can be controlled by adjusting the quantity of polar functional groups in the binder resin, the quantity of binder resin, and/or the dispersion time in the dispersion device to control the number of protrusions on the surface of the magnetic layer. Further, the quantity of carbon black and abrasive employed in the magnetic layer potentially becoming protrusions, and the dispersion method, can be adjusted to control the number of protrusions on the surface of the magnetic layer. Further, methods such as changing the calendering conditions (temperature, pressure, hardness of calender rolls, and the like) and incorporating metal calender rolls can be used to adjust the number of protrusions on the surface of the magnetic layer through relatively intense calendering.

### Carbonic Ester

The magnetic recording medium of the present invention comprises a carbonic ester having a molecular weight ranging from 360 to 460 in the magnetic layer. The number of protrusions on the surface of the magnetic layer in the magnetic recording medium of the present invention is as stated above. In a magnetic layer of such high surface smoothness, when a large quantity of lubricant is present on the surface of the magnetic layer and the medium and a head are stored in a state of contact, the surface tension due to liquid lubricant acting between the medium surface and the head increases markedly, the medium surface sticks to the head, and running becomes difficult during renewed running. By contrast, since carbonic esters can ensure a lubricating property even when present on the surface in smaller quantity than the fatty ester-based lubricants commonly employed, sticking can be avoided. However, the medium still ends up sticking to the head due to surface tension with carbonic esters having a molecular weight of less than 360 because such carbonic esters tend to seep onto the medium surface when a medium and head are left for an extended period following running. Conversely, when a molecular weight of 460 is exceeded, precipitates tend to form on the medium surface during running and storage. The molecular weight is preferably 370 to 430, more preferably 400 to 430.

A lubricant with good resistance to hydrolysis is desirably employed to achieve good running durability. From this perspective, the carbonic ester denoted by general formula (1) below is desirably employed as the above-described carbonic ester.

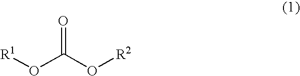

In general formula (1), R¹ and R² each independently denote a saturated hydrocarbon group. To achieve good resistance to hydrolysis, one from among R¹ and R² desirably denotes a saturated hydrocarbon group having a branched structure. The branched structure may be at either the α or β position, but from the perspective of achieving good running durability, the branched structure is desirably at the β position. The saturated hydrocarbon group having a branched structure comprises, for example, 4 to 8, preferably 5 to 8, carbon atoms. Specific desirable examples of the saturated hydrocarbon group having a branched structure are: 2-methylpropyl, 2-methylbutyl, and 2-ethylhexyl groups.

When one from among R¹ and R² in general formula (1) denotes a saturated hydrocarbon group having a branched structure, the other desirably denotes a saturated hydrocarbon group having a linear structure. The saturated hydrocarbon group having a linear structure preferably comprises 14 to 20, more preferably 16 to 18, carbon atoms. Specific desirable examples of the saturated hydrocarbon group having a linear structure are: butyl, hexyl, octyl, decyl, dodecyl, tetradecyl, and hexadecyl groups.

The carbonic ester can be synthesized by known methods. An example of a synthesis method is the method of reacting chloroformic ester and an alcohol having the above-described hydrocarbon group. Specific examples of the chloroformic ester serving as starting material in the synthesis reaction are: 2-methylpropyl, 2-methylbutyl, and 2-ethylhexyl groups. The carbonic esters may be available as a commercial product.

The content of the carbonic ester in the magnetic layer is, for example, 0.5 to 5 weight percent, preferably 1 to 2.5 weight percent, and more preferably, 1 to 1.5 weight percent. A single type of the above carbonic ester may be employed, or two or more types may be mixed for use.

The carbonic ester may also be incorporated into the nonmagnetic layer. Incorporating the carbonic ester into the nonmagnetic layer can serve to control the quantity of carbonic ester in the nonmagnetic layer that gradually migrates to the magnetic layer side and seeps onto the surface during running and storage. This is advantageous in terms of maintaining good running durability and storage properties. In this case, for example, the carbonic esters having different melting points can be employed in the nonmagnetic layer and magnetic layer to control seepage onto the surface; the carbonic esters having different boiling points and polarities can be used to control seepage onto the surface; the quantity of surfactant can be adjusted to enhance coating stability; and the quantity of the carbonic ester added to the nonmagnetic layer can be increased to control the quantity of the carbonic ester present on the surface of the magnetic layer during running and storage. The content of the carbonic ester in the nonmagnetic layer is, for example, 0.5 to 5 weight percent, preferably 1 to 2.5 weight percent, and more preferably, 1 to 1.5 weight percent.

### Polyurethane Resin

In the magnetic recording medium of the present invention, a polyurethane resin with a weight average molecular weight ranging from 100,000 to 200,000 is comprised in the magnetic layer. With a polyurethane resin having a weight average molecular weight of less than 100,000, there is a large amount of migration of low molecular weight components of the binder onto the surface of the magnetic layer, binder flow occurs during repeated running, the frictional force increases during high-speed running, and running durability decreases. Conversely, with a polyurethane resin having a weight average molecular weight of higher than 200,000, the viscosity of the magnetic layer coating liquid increases and it becomes difficult to obtain a smooth magnetic layer. In the present invention, the use of a polyurethane resin having a weight average molecular weight within the above-stated range as binder in the magnetic layer can achieve both running stability and smoothness of the magnetic layer. The weight average molecular weight is preferably 100,000 to 150,000, more preferably 100,000 to 140,000.

From the perspective of maintaining good surface properties in the magnetic layer, polyurethane resin (A) and polyurethane resin (B) below, which may have suitable viscosities, are desirably employed as the above-described polyurethane resin. Polyurethane resin (A): A polyurethane resin with a weight average molecular weight ranging from 100,000 to 200,000 in the form of a reaction product of a polyether polyol; a short-chain diol having a bridged hydrocarbon structure denoted by the following (a) and/or a bridged hydrocarbon structure denoted by the following (b); and an organic diisocyanate.

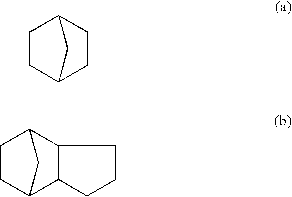

Polyurethane resin (B): A polyurethane resin with a weight average molecular weight ranging from 100,000 to 200,000 in the form of a reaction product of a polyester polyol having a weight average molecular weight ranging from 100,000 to 200,000, comprising an aliphatic dibasic acid and an aliphatic diol not having a cyclic structure but comprising a branched alkyl side chain; an aliphatic diol having a branched alkyl side chain with a total carbon number of equal to or more than 3; and an organic diisocyanate.

Polyurethane resins (A) and (B) will be described below.

### (i) Polyurethane Resin (A)

Aliphatic polyethers such as polyethylene oxide, polypropylene oxide, and polytetramethylene glycol; aromatic polyethers obtained by adding an ethylene oxide, propylene oxide, or the like to an aromatic glycol such as bisphenol A; and the like may be employed singly or in combination as the polyether polyol constituting polyurethane resin (A). The molecular weight of the polyether polyol desirably ranges from 500 to 3,000. Good dispersibility can be achieved within this range.

The short-chain diol constituting polyurethane resin (A) has the bridged hydrocarbon structure denoted by (a) below and/or the bridged hydrocarbon structure denoted by (b) below. In the present invention, the term “short-chain diol” refers, for example, to a diol with a weight average molecular weight of equal to or less than 500. By way of example, the lower limit of the weight average molecular weight of the short-chain diol may be 50.

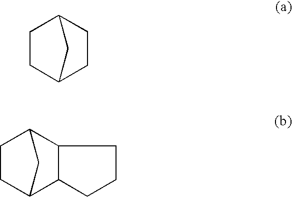

Polyurethane resin (A) can be obtained by reacting the various above-listed components using a common polyurethane resin synthesis method. Polyurethane resin (A) is desirably obtained by polymerizing a prescribed quantity of organic diisocyanate with 10 to 50 weight percent of the above polyether polyol and 15 to 40 weight percent of the above short-chain diol.

### (ii) Polyurethane Resin (B)

The polyester polyol constituting polyurethane resin (B) comprises an aliphatic dibasic acid and an aliphatic diol not having a cyclic structure but comprising a branched alkyl side chain.

The aliphatic dibasic acid does not have a cyclic structure of low solvent solubility and is thus desirable because it readily dissolves uniformly in solvent. Examples of aliphatic dibasic acids that can be employed in polyester polyols are: succinic acid, adipic acid, azelaic acid, sebacic acid, malonic acid, glutaric acid, pimelic acid, and suberic acid. Of these, succinic acid, adipic acid, and sebacic acid are desirable. Of the total dibasic acid component content of the polyester polyol, an aliphatic dibasic acid content of 70 to 100 molar percent is desirable from the perspective of achieving good solubility.

The diol component contained in the above polyester polyol is an aliphatic diol that has a branched alkyl side chain but does not have a cyclic structure. When the diol component in the polyester polyol comprises a branched alkyl side chain, intermolecular interaction can be reduced and binder solubility can be enhanced because association between urethane bonds and ester bonds can be prevented by steric hindrance. Ensuring the absence of cyclic structures of low solubility, such as aromatic rings and cyclohexane rings, can increase the solubility of the binder. Thus, the binder can dissolve uniformly in the solvent, permitting a high degree of dispersion of magnetic material and nonmagnetic powder.

The above polyurethane resin may comprise a polar group. Examples of desirable polar groups are —SO₃M, —OSO₃M, —PO₃M₂, —COOM (where M is selected from among a hydrogen atom, an alkali metal, or ammonium). Preferred examples are —SO₃M and —OSO₃M. The content of the polar group is desirably 1×10⁻⁵ to 5×10⁻⁴ eq/g. At 1×10⁻⁵ eq/g and above, high adsorption to the magnetic material and nonmagnetic powder can be achieved to obtain good dispersion; at 5×10⁻⁴ eq/g and below, high solvent solubility can be achieved.

The number of OH group in the polyurethane resin is preferably 2 to 20 per molecule, more preferably 3 to 15 per molecule. The incorporation of 2 or more OH groups per molecule can ensure good dispersion and increased adsorption to the magnetic material and nonmagnetic powder, while the number of OH group of 20 or fewer per molecule can yield high solubility in solvent.

### Other Binder Components

Polyester resins, polyamide resins, vinyl chloride resins, acrylic resins obtained through copolymerization of styrene, acrylonitrile, methyl methacrylate and the like, nitrocellulose and other cellulose resins, epoxy resins, phenoxy resins, polyvinyl acetal, polyvinyl butyral and other polyvinyl alkyral resins can be employed independently or in mixtures of two or more as binder components in the magnetic layer in addition to the above polyurethane binder. Of these, vinyl chloride resins and acrylic resins are desirable as binder components.

The above binder components desirably have functional groups (polar groups) that adsorb to the surfaces of the magnetic material and nonmagnetic powder to enhance dispersion thereof. Desirable functional groups include: —SO₃M, —SO₄M, —PO(OM)₂, —OPO(OM)₂, —COOM, >NSO₃M, >NRSO₃M, —NR¹R², and —N⁺R¹R²R³X⁻. M denotes a hydrogen atom or an alkali metal such as Na or K; R denotes an alkylene group; R¹, R², and R³ each independently denote alkyl groups, hydroxyalkyl groups, or hydrogen; and X denotes a halogen such as Cl or Br. The quantity of functional groups in the binder is preferably 10 to 200 μeq/g, more preferably 30 to 120 μeq/g. Within this range, good dispersion can be obtained. Additionally, functional groups comprising active hydrogen, such as OH groups, may also be present.

Vinyl chloride resins obtained by copolymerizing various monomers with vinyl chloride monomer can be employed. The monomer that is copolymerized may be in the form of vinyl acetate, vinyl propionate, and other fatty acid vinyl esters; methyl(meth)acrylate, ethyl(meth)acrylate, isopropyl(meth)acrylate, butyl(meth)acrylate, benzyl(meth)acrylate, and other acrylates and methacrylates; and allyl methyl ether, allyl ethyl ether, allyl propyl ethyl, allyl butyl ether, and other alkyl allyl ethers. Additionally, styrene, α-methylstyrene, vinylidene chloride, acrylonitrile, ethylene, butadiene, and acrylamide may be employed. Functional group-comprising copolymerizable monomers in the form of vinyl alcohol, 2-hydroxyethyl(meth)acrylate, polyethylene glycol(meth)acrylate, 2-hydroxypropyl(meth)acrylate, 3-hydroxypropyl(meth)acrylate, polypropylene glycol(meth)acrylate, 2-hydroxyethylallyl ether, 2-hydroxypropylallyl ether, 3-hydroxpropylallyl ether, p-vinylphenol, maleic acid, maleic anhydride, acrylic acid, methacrylic acid, glycidyl(meth)acrylate, allylglycidyl ether, phosphoethyl(meth)acrylate, sulfoethyl(meth)acrylate, p-styrenesulfonic acid, and Na and K salts thereof can be employed. The vinyl chloride monomer desirably constitutes 60 to 95 weight percent of the vinyl chloride resin. Within this range, mechanical strength can be high, coating liquid viscosity can be low due to high solubility in solvent, and dispersibility can be good.

The adsorptive functional group (polar group) can be introduced by copolymerization of the above functional group-comprising monomers, or by copolymerizing vinyl chloride resin, and then introducing the functional group in a polymeric reaction. A polymerization degree of 200 to 600 is desirable, with 240 to 450 being preferred. Within this range, high mechanical strength can be obtained and good dispersibility can be achieved due to low solution viscosity.

The weight average molecular weight of the above-described binder components other than polyurethane resin is preferably 20,000 to 200,000, more preferably 20,000 to 80,000. Within this range, coating strength and coating liquid viscosity can be good.

The total content of the binder component in the magnetic layer is preferably 10 to 30 weight parts, more preferably 15 to 25 weight parts, per 100 weight parts of ferromagnetic powder. When employing a polyurethane resin with a weight average molecular weight ranging from 100,000 to 200,000 in combination with other binder components, the ratio of the polyurethane to the total quantity of binder components (the ratio when the weight of the binder added is 100 percent) is preferably equal to or greater than 10 weight percent, more preferably 15 to 70 weight percent. The polyurethane resin having a weight average molecular weight ranging from 100,000 to 200,000 or binders other than the above polyurethane resin can be employed as a binder component in the nonmagnetic layer. Alternatively, the above polyurethane resin and other binders can be employed in combination in the nonmagnetic layer. The quantity of binder component employed in the nonmagnetic layer is desirably 10 to 30 weight parts per 100 weight parts of nonmagnetic powder.

### Magnetic Layer

The magnetic layer in the magnetic recording medium of the present invention will be described below.

Ferromagnetic metal powder and hexagonal ferrite powder can be employed as the ferromagnetic powder in the magnetic layer. Details thereof will be described below. However, the ferromagnetic powder employed in the present invention is not limited to the ferromagnetic metal powder and hexagonal ferrite powder. For example, nitriding iron powders and the like may be employed.

(i) Ferromagnetic Metal Powder

The ferromagnetic metal powder employed in the magnetic layer is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014, which are expressly incorporated herein by reference in their entirety.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed in the magnetic layer is preferably 45 to 100 m²/g, more preferably 50 to 80 m²/g. At 45 m²/g and above, low noise is achieved. At 100 m²/g and below, good surface properties are achieved. The crystallite size of the ferromagnetic metal powder is preferably 80 to 180 Angstroms, more preferably 100 to 180 Angstroms, and still more preferably, 110 to 175 Angstroms. The major axis length of the ferromagnetic metal powder is preferably equal to or greater than 10nm and equal to or less than 150 nm, more preferably equal to or greater than 20 nm and equal to or less than 150 nm, and still more preferably, equal to or greater than 30 nm and equal to or less than 120 nm. The acicular ratio of the ferromagnetic metal powder is preferably equal to or greater than 3 and equal to or less than 15, more preferably equal to or greater than 5 and equal to or less than 12. The σₛ of the ferromagnetic metal powder is preferably 100 to 180 A·m²/kg, more preferably 110 to 170 A·m²/kg, and still more preferably, 125 to 160 A·m²/kg. The coercivity of the ferromagnetic powder is preferably 2,000 to 3,500 Oe, approximately 160 to 280 kA/m, more preferably 2,200 to 3,000 Oe, approximately 176 to 240 kA/m.

The moisture content of the ferromagnetic metal powder is desirably 0.01 to 2 percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 weight percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at equal to or less than 200 ppm. The ferromagnetic metal powder employed in the present invention desirably has few voids; the level is preferably equal to or less than 20 volume percent, more preferably equal to or less than 5 volume percent. As stated above, so long as the particle size characteristics are satisfied, the ferromagnetic metal powder may be acicular, rice grain-shaped, or spindle-shaped. The SFD of the ferromagnetic metal powder itself is desirably low, with equal to or less than 0.8 being preferred. The Hc distribution of the ferromagnetic metal powder is desirably kept low. When the SFD is equal to or lower than 0.8, good electromagnetic characteristics are achieved, output is high, and magnetic inversion is sharp, with little peak shifting, in a manner suited to high-density digital magnetic recording. To keep the Hc low, the methods of improving the particle size distribution of goethite in the ferromagnetic metal powder and preventing sintering may be employed.

(ii) Hexagonal Ferrite Powder

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

When the length of the signal recording region approaches the size of the magnetic material contained in the magnetic layer, it becomes impossible to create a distinct magnetization transition state, essentially precluding recording. Thus, the shorter the recording wavelength becomes, the smaller the magnetic material should be. In the present invention, to achieve good recording in the short-wavelength region, the use of hexagonal ferrite powder having a mean plate diameter falling within a range of 10 to 40 nm is preferable, a range of 15 to 30 nm is more preferable, and a range of 20 to 25 nm is of still greater preference.

An average plate ratio [arithmetic average of (plate diameter/plate thickness)] preferably ranges from 1 to 15, more preferably 1 to 7. When the average plate diameter ranges from 1 to 15, adequate orientation can be achieved while maintaining high filling property, as well as increased noise due to stacking between particles can be suppressed. The specific surface area by BET method (SBET) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure the particle plate diameter and plate thickness. The distributions of particle plate diameter and plate thickness are often not a normal distribution. However, when expressed as the standard deviation to the average size, a/average size may be 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of about 143.3 to 318.5 kA/m (approximately 1800 to 4,000 Oe) can normally be achieved. The coercivity (Hc) of the hexagonal ferrite powder preferably ranges from 159.2 to 238.9 kA/m (approximately 2,000 to 3,000 Oe), more preferably 191.0 to 214.9 kA/m (approximately 2,200 to 2,800 Oe). The coercivity (Hc) can be controlled by particle size (plate diameter and plate thickness), the types and quantities of elements contained, substitution sites of the element, the particle producing reaction conditions, and the like.

The saturation magnetization (σₛ) of the hexagonal ferrite powder can be 30 to 80 A·m²/kg (30 to 80 emu/g). The higher saturation magnetization (σₛ) is preferred, however, it tends to decrease with decreasing particle size. Known methods of improving saturation magnetization (as) are combining spinel ferrite with magnetoplumbite ferrite, selection of the type and quantity of elements incorporated, and the like. It is also possible to employ W-type hexagonal ferrite. When dispersing the hexagonal ferrite powder, the surface of the hexagonal ferrite powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added can range from 0.1 to 10 weight percent relative to the weight of the hexagonal ferrite powder. The pH of the hexagonal ferrite powder is also important to dispersion. A pH of about 4 to 12 is usually optimum for the dispersion medium and polymer. From the perspective of the chemical stability and storage properties of the medium, a pH of about 6 to 11 can be selected. Moisture contained in the hexagonal ferrite powder also affects dispersion. There is an optimum level for the dispersion medium and polymer, usually selected from the range of 0.01 to 2.0 weight percent.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity can be set to 0.1 to 10 weight percent of the hexagonal ferrite powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

Known techniques regarding binders, lubricants, dispersion agents, additives, solvents, dispersion methods and the like for magnetic layer, nonmagnetic layer described further below and backcoat layer can be suitably applied. In particular, known techniques regarding the quantity and types of binders, and quantity added and types of additives and dispersion agents can be applied.

Additives may be added to the magnetic layer and nonmagnetic layer described further below, as needed. Examples of such additives are: abrasives, lubricants, dispersing agents, dispersing adjuvants, antifungal agents, antistatic agents, oxidation inhibitors, solvents, and carbon black. The lubricant components indicated below, for example, can be employed with the above-described carbonic ester as lubricant components of the magnetic layer and nonmagnetic layer. To reduce the friction during low-speed running, fatty acids such as stearic acid are suitably incorporated as lubricants in combination with the above carbonic ester. The quantity of the lubricant employed with the carbonic ester is preferably 0.5 to 3 weight parts, more preferably 0.5 to 1.5 weight parts, per 100 weight parts of ferromagnetic or nonmagnetic powder.

Examples of additives are: molybdenum disulfide, tungsten disulfide, graphite, boron nitride, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F, Cl, Br, CF₃, CCl₃, CBr₃, and other halogen-containing hydrocarbons in addition to the above hydrocarbon groups, may also be employed. partially graphite-treated surface. The carbon black may be dispersed in advance into the binder prior to addition to the magnetic coating liquid. These carbon blacks may be used singly or in combination. When employing carbon black, the quantity preferably ranges from 0.1 to 30 weight percent with respect to the weight of the magnetic material. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association, which is expressly incorporated herein by reference in its entirety, may be consulted for types of carbon black suitable for use in the magnetic layer.

Known materials chiefly having a Mohs' hardness of equal to or greater than 6 may be employed either singly or in combination as abrasives. These include: α-alumina with an α-conversion rate of equal to or greater than 90 percent, β-alumina, silicon carbide, chromium oxide, cerium oxide, α-iron oxide, corundum, synthetic diamond, silicon nitride, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed may be acicular, spherical, cubic, plate-shaped or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co.,Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle size and quantity of the abrasives added to the magnetic layer and nonmagnetic layer should be set to optimal values.

Known organic solvents can be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane.

These organic solvents need not be 100 weight percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. Preferably the same type of organic solvent is employed in the magnetic layer and in the nonmagnetic layer. However, the amount added may be varied. The stability of coating is increased by using a solvent with a high surface tension (such as cyclohexanone or dioxane) in the nonmagnetic layer. Specifically, it is important that the arithmetic mean value of the magnetic layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 percent of the solvent composition. Further, the dissolution parameter is desirably 8 to 11.

The types and quantities of dispersing agents, lubricants, and surfactants employed in the magnetic layer may differ from those employed in the nonmagnetic layer, described further below, in the present invention. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic metal powder, and in the nonmagnetic layer, primarily to the surface of the nonmagnetic powder. It is surmised that once an organic phosphorus compound has adsorbed or bonded, it tends not to dislodge readily from the surface of a metal, metal compound, or the like. Accordingly, the surface of a ferromagnetic metal powder or the surface of a nonmagnetic powder becomes covered with the alkyl group, aromatic groups, and the like. This enhances the compatibility of the ferromagnetic metal powder or nonmagnetic powder with the binder resin component, further improving the dispersion stability of the ferromagnetic metal powder or nonmagnetic powder. Further, lubricants are normally present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

### Nonmagnetic Layer

Details of the nonmagnetic layer will be described below. The magnetic recording medium of the present invention may comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm to 500 nm, more preferably from 40 to 100 nm. A crystallite size falling within a range of 4 nm to 500nm is desirable in that it facilitates dispersion and imparts a suitable surface roughness. The average particle diameter of the nonmagnetic powder preferably ranges from 5 nm to 500 nm. As needed, nonmagnetic powders of differing average particle diameter may be combined; the same effect may be achieved by broadening the average particle distribution of a single nonmagnetic powder. The preferred average particle diameter of the nonmagnetic powder ranges from 10 to 200 nm. Within a range of 5 nm to 500nm, dispersion is good and good surface roughness can be achieved.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, suitable surface roughness can be achieved and dispersion is possible with the desired quantity of binder. Oil absorption capacity using dibutyl phthalate (DBP) preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder ranges from, for example, 0.1 to 5 weight percent, preferably from 0.2 to 3 weight percent, and more preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (approximately 200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders is preferably treated with Al₂O₃, SiO₂, TiO₂, ZrO₂, SnO₂, Sb₂O₃, and ZnO. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders suitable for use in the nonmagnetic layer in the present invention are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, MT-600B, MT-100F and MT-50OHD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally 25 to 60 kg/mm² (approximately 245 to 588 MPa), desirably 30 to 50 kg/mm² (approximately 294 to 490 MPa) to adjust head contact. It can be measured with a thin film hardness meter (HMA-400 made by NEC Corporation) using a diamond triangular needle with a tip radius of 0.1 micrometer and an edge angle of 80 degrees as indenter tip. “Techniques for evaluating thin-film mechanical characteristics,” Realize Corp., for details. The content of the above publication is expressly incorporated herein by

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.), which is expressly incorporated herein by reference in its entirety.

These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co.,Ltd.; NJLUB OL manufactured by New Japan Chemical Co. Ltd.; TA-3 manufactured by Shin-Etsu Chemical Co. Ltd.; Armide P and Duomine TDO manufactured by Lion Corporation; BA-41G manufactured by Nisshin OilliO, Ltd.; and Profan 2012E, Newpole PE61 and Ionet MS-400 manufactured by Sanyo Chemical Industries, Ltd.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml.

Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a the above applications are expressly incorporated herein by reference in their entirety.

Binders, lubricants, dispersing agents, additives, solvents, dispersion methods, and the like suited to the magnetic layer may be adopted to the nonmagnetic layer. In particular, known techniques for the quantity and type of binder and the quantity and type of additives and dispersion agents employed in the magnetic layer may be adopted thereto.

### Nonmagnetic Support

Known films of the following may be employed as the nonmagnetic support in the present invention: polyethylene terephthalate, polyethylene naphthalate and other polyesters, polyolefins, cellulose triacetate, polycarbonate, polyamides, polyimides, polyamidoimides, polysulfones, aromatic polyamides, polybenzooxazoles and the like. Supports having a glass transition temperature of equal to or higher than 100° C. are preferably employed. The use of polyethylene naphthalate, aramid, or some other high-strength support is particularly desirable. As needed, layered supports such as disclosed in Japanese Unexamined Patent Publication (KOKAI) Heisei No. 3-224127, which is expressly incorporated herein by reference in its entirety, may be employed to vary the surface roughness of the magnetic surface and support surface. These supports may be subjected beforehand to corona discharge treatment, plasma treatment, adhesion enhancing treatment, heat treatment, dust removal, and the like.

The center surface average surface roughness (SRa) of the support measured with an optical interferotype surface roughness meter HD-2000 made by WYKO is preferably equal to or less than 8.0 nm, more preferably equal to or less than 4.0 nm, further preferably equal to or less than 2.0 nm. Not only does such a support desirably have a low center surface average surface roughness, but there are also desirably no large protrusions equal to or higher than 0.5 μm. The surface roughness shape may be freely controlled through the size and quantity of filler added to the support as needed. Examples of such fillers are oxides and carbonates of elements such as Ca, Si, and Ti, and organic fine powders such as acrylic-based one. The support desirably has a maximum height Rₘₐₓ equal to or less than 1 μm, a ten-point average roughness R_{Z} equal to or less than 0.5 μm, a center surface peak height R_{P} equal to or less than 0.5 μm, a center surface valley depth R_{V} equal to or less than 0.5 μm, a center-surface surface area percentage Sr of 10 percent to 90 percent, and an average wavelength λₐ of 5 to 300 μm. To achieve desired electromagnetic characteristics and durability, the surface protrusion distribution of the support can be freely controlled with fillers. It is possible to control within a range from 0 to 2,000 protrusions of 0.01 to 1 μm in size per 0.1 mm².

The F-5 value of the nonmagnetic support employed in the present invention preferably ranges from 5 to 50 kg/mm² (approximately 49 to 490 MPa). The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength of the nonmagnetic support preferably ranges from 5 to 100 kg/mm² (approximately 49 to 980 MPa). The modulus of elasticity preferably ranges from 100 to 2,000 kg/mm² (approximately 0.98 to 19.6 GPa). The thermal expansion coefficient preferably ranges from 10⁻⁴ to 10⁻⁸/° C., more preferably from 10⁻⁵ to 10⁻⁶/° C. The moisture expansion coefficient is preferably equal to or less than 10⁻⁴/RH percent, more preferably equal to or less than 10⁻⁵/RH percent. These thermal characteristics, dimensional characteristics, and mechanical strength characteristics are desirably nearly equal, with a difference equal to less than 10 percent, in all in-plane directions in the support.

An undercoating layer can be provided in the magnetic recording medium of the present invention. Providing an undercoating layer can enhance adhesive strength between the support and the magnetic layer or nonmagnetic layer. For example, a polyester resin that is soluble in solvent can be employed as the undercoating layer to enhance adhesion. As described below, a smoothing layer can be provided as an undercoating layer.

### Layer Structure

In the magnetic recording medium of the present invention, the thickness of the nonmagnetic support preferably ranges from 3 to 80 micrometers, more preferably from 3 to 50 micrometers, further preferably from 3 to 10 micrometers. When an undercoating layer is provided between the nonmagnetic support and the nonmagnetic layer or the magnetic layer, the thickness of the undercoating layer ranges from, for example, 0.01 to 0.8 micrometer, preferably 0.02 to 0.6 micrometer.

An intermediate layer can be provided between the support and the nonmagnetic layer or the magnetic layer and/or between the support and the backcoat layer to improve smoothness. For example, the intermediate layer can be formed by coating and drying a coating liquid comprising a polymer on the surface of the nonmagnetic support, or by coating a coating liquid comprising a compound (radiation-curable compound) comprising intramolecular radiation-curable functional groups and then irradiating it with radiation to cure the coating liquid.

A radiation-curable compound having a number average molecular weight ranging from 200 to 2,000 is desirably employed. When the molecular weight is within the above range, the relatively low molecular weight can facilitate coating flow during the calendering step, increasing moldability and permitting the formation of a smooth coating.

A radiation-curable compound in the form of a bifunctional acrylate compound with the molecular weight of 200 to 2,000 is desirable. Bisphenol A, bisphenol F, hydrogenated bisphenol A, hydrogenated bisphenol F, and compounds obtained by adding acrylic acid or methacrylic acid to alkylene oxide adducts of these compounds are preferred.

The radiation-curable compound can be used in combination with a polymeric binder. Examples of the binder employed in combination are conventionally known thermoplastic resins, thermosetting resins, reactive resins, and mixtures thereof. When the radiation employed in the curing process is UV radiation, a polymerization initiator is desirably employed in combination. A known photoradical polymerization initiator, photocationic polymerization initiator, photoamine generator, or the like can be employed as the polymerization initiator.

A radiation-curable compound can also be employed in the nonmagnetic layer.

The thickness of the magnetic layer can be optimized based on the saturation magnetization of the head employed, the length of the head gap, and the recording signal band, and is normally 10 to 150 nm, preferably 20 to 120 nm, more preferably 30 to 100 nm, and further preferably 30 to 80 nm. The thickness variation (σ/δ) in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.3 to 2.0 μm, and more preferably 0.5 to 1.5 μm. The nonmagnetic layer of the present invention is effective so long as it is substantially nonmagnetic. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercive force Hc of equal to or less than 7.96 kA/m (100 Oe), it being preferable not to have a residual magnetic flux density or coercive force at all.

### Backcoat Layer

A backcoat layer is desirably provided on the surface of the nonmagnetic support, opposite to the surface on which the magnetic layer is provided. The backcoat layer desirably comprises carbon black and inorganic powder. The formula of the magnetic layer or nonmagnetic layer can be applied to the binder and various additives of the backcoat layer. The formula of the nonmagnetic layer is preferred. The backcoat layer is preferably equal to or less than 0.9 micrometer, more preferably 0.1 to 0.7 micrometer, in thickness.

### Manufacturing Method

The process for manufacturing coating liquids for forming magnetic, nonmagnetic and backcoat layers comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the coating liquids for magnetic, nonmagnetic and backcoat layers, with a dispersing medium with a high specific gravity such as zirconia beads, titania beads, and steel beads being suitable for use. The particle diameter and fill ratio of these dispersing media can be optimized for use. A known dispersing device may be employed. In manufacturing coating liquids, dispersion is preferably enhanced by controlling dispersion conditions (such as types and quantities of beads employed in dispersion, peripheral speed, and dispersion period).

When coating a magnetic recording medium of multilayer configuration, both a wet-on-wet method and a wet-on-dry method can be employed. In the wet-on-wet method, a coating liquid for forming a nonmagnetic layer is coated, and while this coating is still wet, a coating liquid for forming a magnetic layer is coated thereover and dried. In the wet-on-dry method, a coating liquid for forming a nonmagnetic layer is coated and dried to form a nonmagnetic layer, and then a coating liquid for forming a magnetic layer is coated on the nonmagnetic layer and dried.

When using the wet-on-wet method, the following methods are desirably employed;

(1) a method in which the nonmagnetic layer is first coated with a coating device commonly employed to coat magnetic coating materials such as a gravure coating, roll coating, blade coating, or extrusion coating device, and the magnetic layer is coated while the nonmagnetic layer is still wet by means of a support pressure extrusion coating device such as is disclosed in Japanese Examined Patent Publication (KOKOKU) Heisei No. 1-46186 and Japanese Unexamined Patent Publication (KOKAI) Showa No. 60-238179 and Japanese Unexamined Patent Publication (KOKAI) Heisei No. 2-265672, which are expressly incorporated herein by reference in their entirety;

(2) a method in which the upper and lower layers are coated nearly simultaneously by a single coating head having two built-in slits for passing coating liquid, such as is disclosed in Japanese Unexamined Patent Publication (KOKAI) Showa No. 63-88080, Japanese Unexamined Patent Publication (KOKAI) Heisei No. 2-17971, and Japanese Unexamined Patent Publication (KOKAI) Heisei No. 2-265672, which are expressly incorporated herein by reference in their entirety; and

(3) a method in which the upper and lower layers are coated nearly simultaneously using an extrusion coating apparatus with a backup roller as disclosed in Japanese Unexamined Patent Publication (KOKAI) Heisei No. 2-174965, which is expressly incorporated herein by reference in its entirety. To avoid deteriorating the electromagnetic characteristics or the like of the magnetic recording medium by aggregation of magnetic particles, shear is desirably imparted to the coating liquid in the coating head by a method such as disclosed in Japanese Unexamined Patent Publication (KOKAI) Showa No. 62-95174 or Japanese Unexamined Patent Publication (KOKAI) Heisei No. 1-236968, which are expressly incorporated herein by reference in their entirety. In addition, the viscosity of the coating liquid preferably satisfies the numerical range specified in Japanese Unexamined Patent Publication (KOKAI) Heisei No. 3-8471, which are expressly incorporated herein by reference in its entirety.

Coating of coating liquid for each layer can be carried out with a coating device commonly employed to coat magnetic coating materials such as a gravure coating, roll coating, blade coating, or extrusion coating device.

When the magnetic recording medium of the present invention is a magnetic tape, the coating layer that is formed by applying the magnetic layer coating liquid can be magnetic field orientation processed using cobalt magnets or solenoids on the ferromagnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions in response to the smoothness of the surface of the coated stock material.

The glossiness of the coated stock material may decrease roughly from the center of the take-up roll toward the outside, and there is sometimes variation in the quality in the longitudinal direction. Glossiness is known to correlate (proportionally) to the surface roughness Ra. Accordingly, when the calendering conditions are not varied in the calendering step, such as by maintaining a constant calender roll pressure, there is no countermeasure for the difference in smoothness in the longitudinal direction resulting from winding of the coated stock material, and the variation in quality in the lengthwise direction tends to carry over into the final product.

Accordingly, in the calendering step, it is desirable to vary the calendering conditions, such as the calender roll pressure, to cancel out the different in smoothness in the longitudinal direction that is produced by winding of the coated stock material. reference in its entirety. The light transmittance is generally standardized to an infrared absorbance at a wavelength of about 900 nm equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL

Specific examples of types of carbon black employed in the nonmagnetic layer are: BLACK PEARLS 2000, 1300, 1000, 900, 905, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the nonmagnetic coating liquid. These carbon blacks may be used singly or in combination. When employing carbon black, the quantity of the carbon black is preferably within a range not exceeding 50 weight percent of the inorganic powder as well as not exceeding 40 weight percent of the total weight of the nonmagnetic layer. For example, the Carbon Black Handbook compiled by the Carbon Black Association, which is expressly incorporated herein by reference in its entirety, may be consulted for types of carbon black suitable for use in the nonmagnetic layer.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of Specifically, it is desirable to reduce the calender roll pressure from the center to the outside of the coated stock material that is wound off the take-up roll. Based on an investigation by the present inventors, lowering the calender roll pressure decreases the glossiness (smoothness diminishes). Thus, the difference in smoothness in the longitudinal direction that is produced by winding of the coated stock material is cancelled out, yielding a final product free of variation in quality in the longitudinal direction.

An example of changing the pressure of the calender rolls has been described above. Additionally, it is possible to control the calender roll temperature, calender roll speed, and calender roll tension. Taking into account the properties of a particulate medium, it is desirable to control the surface smoothness by means of the calender roll pressure and calender roll temperature. Generally, the calender roll pressure is reduced, or the calender roll temperature is lowered, to diminish the surface smoothness of the final product. Conversely, the calender roll pressure can be increased or the calender roll temperature can be raised to increase the surface smoothness of the final product.

Rolls of a heat-resistant plastic such as epoxy, polyimide, polyamide, or polyamidoimide, can be employed as the calender rolls. Processing with metal rolls is also possible.

As for the calendaring conditions, the calender roll temperature ranges from, for example, 60 to 100° C., preferably 70 to 100° C., and more preferably 80 to 100° C. The pressure ranges from, for example, 100 to 500 kg/cm (98 to 490 kN/m), preferably 200 to 450 kg/cm (196 to 441 kN/m), and more preferably 300 to 400 kg/cm (294 to 392 kN/m).

The magnetic recording medium obtained can be cut to desired size with a cutter or the like. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like are suitably selected.

### Physical Characteristics

The saturation magnetic flux density of the magnet layer is preferably 100 to 400 mT. The coercivity (Hc) of the magnetic layer is preferably 143.2 to 318.3 kA/m (approximately 1,800 to 4,000 Oe), more preferably 159.2 to 278.5 kA/m (approximately 2,000 to 3,500 Oe). Narrower coercivity distribution is preferable. The SFD and SFDr are preferably equal to or lower than 0.6, more preferably equal to or lower than 0.3.

The coefficient of friction of the magnetic recording medium relative to the head is, for example, equal to or less than 0.5 and preferably equal to or less than 0.3 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (approximately 100 to 2,000 kg/mm²) in each in-plane direction. The breaking strength preferably ranges from 98 to 686 MPa (approximately 10 to 70 kg/mm²). The modulus of elasticity of the magnetic recording medium preferably ranges from 0.98 to 14.7 GPa (approximately 100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz with a dynamic viscoelastometer, such as RHEOVIBRON made by A&D Co. Ltd) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (approximately 1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 40 volume percent, more preferably equal to or less than 30 volume percent. Although a low void ratio is preferable for attaining high output, there are some cases in which it is better to ensure a certain level based on the object. For example, in many cases, larger void ratio permits preferred running durability in disk media in which repeat use is important.

Physical properties of the nonmagnetic layer and magnetic layer may be varied based on the objective in the magnetic recording medium of the present invention. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

### EXAMPLES

The present invention will be described in detail below based on examples. However, the present invention is not limited to the examples. The term “parts” given in Examples are weight parts unless specifically stated otherwise.

Magnetic layer coating liquid A (ferromagnetic metal powder)

| Acicular ferromagnetic metal powder | 100 | parts |
|---|---|---|
| Hc: 191 kA/m (approximately 2400 Oe) | | |
| Mean major axis length: 45 nm | | |
| Specific surface area by BET method: 65 m²/g | | |
| Vinyl chloride copolymer (MR-110 made by Nippon Zeon | 3 | parts |
| Co., Ltd.) | | |
| Polyurethane resin (see Table 1) | 19 | parts |
| Phenylphosphonic acid | 4 | parts |
| α-Al₂O₃ (average particle diameter: 0.15 micrometer) | 12 | parts |
| Carbon black (average particle diameter: 20 nm) | 1 | part |
| Cyclohexanone | 110 | parts |
| Methyl ethyl ketone | 100 | parts |
| Toluene | 100 | parts |
| Lubricant (see Table 1) | See Table 1 | |
| Stearic acid | 1 | part |

Magnetic layer coating liquid B (ferromagnetic metal powder)

| Acicular ferromagnetic metal powder | 100 | parts |
|---|---|---|
| Hc: 183 kA/m (approximately 2300 Oe) | | |
| Mean major axis length: 50 nm | | |
| Specific surface area by BET method: 68 m²/g | | |
| Polyurethane resin containing dimer diol as a polyol | 15 | parts |
| Weight average molecular weight: 42,000 | | |
| α-Al₂O₃ (average particle diameter: 0.11 micrometer) | 7 | parts |
| Carbon black (average particle diameter: 100 nm) | 5 | part |
| Cyclohexanone | 30 | parts |
| Methyl ethyl ketone | 90 | parts |
| Toluene | 60 | parts |
| Lubricant (see Table 1) | See Table 1 | |
| Stearic acid | 0.5 | part |

Magnetic layer coating liquid C (hexagonal ferrite powder)

| Ferromagnetic plate-shaped hexagonal ferrite powder | 100 | parts |
|---|---|---|
| Surface treatment agent: Al₂O₃, SiO₂ | | |
| Hc: 199 kA/m (approximately 2500 Oe) | | |
| Plate diameter: 25 nm, plate ratio: 3 | | |
| σs: 50 A · m²/kg (approximately 50 emu/g) | | |
| Polyurethane resin (see Table 1) | 15 | parts |
| Phenylphosphonic acid | 5 | parts |
| α-Al₂O₃ (average particle diameter: 0.15 micrometer) | 10 | parts |
| Carbon black (average particle diameter: 20 nm) | 1 | part |
| Cyclohexanone | 110 | parts |
| Methyl ethyl ketone | 100 | parts |
| Toluene | 100 | parts |
| Lubricant (see Table 1) | See Table 1 | |
| Stearic acid | 1 | part |

Nonmagnetic layer coating liquid

| Inorganic nonmagnetic powder α-iron oxide | 80 | parts |
|---|---|---|
| Surface treatment agent: Al₂O₃, SiO₂ | | |
| Major axis diameter: 0.15 micrometer, acicular ratio: 7 | | |
| Carbon black | 20 | parts |
| DBP oil absorption capacity: 120 ml/100 g | | |
| pH: 8 | | |
| Specific surface area by BET method: 250 m²/g | | |
| Volatile content: 1.5 percent | | |
| Vinyl chloride resin | 13 | parts |
| Polyurethane resin B | 7 | parts |
| Phenylphosphonic acid | 3 | parts |
| Cyclohexanone | 140 | parts |
| Methyl ethyl ketone | 170 | parts |
| Lubricant (see Table 1) | See Table 1 | |
| Stearic acid | 1 | part |

Backcoat Layer Coating Liquid

Kneaded materials (1)

| | | |
|---|---|---|
| Carbon black A (particle diameter: 40 nm) | 100 | parts |
| Nitrocellulose Cellunova | 50 | parts |
| BTH ½ manufactured by Asahi Kasei Corporation | | |
| Polyurethane resin (glass transition temperature: 50° C.) | 40 | parts |
| Dispersion agent | | |
| Copper oleate | 5 | parts |
| Copper phthalocyanine | 5 | parts |
| Precipitated barium sulfate | 5 | parts |
| Methyl ethyl ketone | 500 | parts |
| Toluene | 500 | parts |

Kneaded materials (2)

| | |
|---|---|
| Carbon black B (particle diameter: 100 nm) | 100 parts |
| Nitrocellulose | 40 parts |
| Cellunova BTH ½ manufactured by | |
| Asahi Kasei Corporation | |
| Polyurethane resin | 10 parts |
| Methyl ethyl ketone | 300 parts |
| Toluene | 300 parts |

After prekneading (1) above in a roll mill, it was dispersed with (2) above in a sand grinder. Upon completion, the following were added to prepare a backcoat layer coating liquid.

| | |
|---|---|
| Polyester resin | 5 parts |
| Polyisocyanate | 5 parts |

The various components of the magnetic layer coating liquid and nonmagnetic layer coating liquid shown in Table 1 were kneaded in a continuous kneader and then dispersed using a sand mill. Three parts of polyisocyanate (Coronate L made by Nippon Polyurethane Industry Co., Ltd.) were added to the dispersion of the nonmagnetic layer coating liquid obtained, and 1 part of the same was added to the dispersion of the magnetic layer coating liquid obtained. Forty parts of a mixed solution of methyl ethyl ketone and cyclohexanone were added to each. The mixtures were filtered with a filter having a mean pore size of 1 micrometer to prepare the magnetic layer coating liquid and nonmagnetic layer coating liquid.

### Example 1

The nonmagnetic layer coating liquid obtained was coated to a support 5 micrometer in thickness with a average center surface roughness of 3.8 nm in a quantity calculated to produce a nonmagnetic layer with a thickness of 1.2 micrometers upon drying, and immediately thereafter, magnetic layer coating liquid A was coated (simultaneous multilayer coating) in a quantity calculated to produce a magnetic layer 0.1 micrometer in thickness. While both layers were still wet, orientation was conducted with magnets having a magnetic force of 0.3 T. Subsequently, a backcoat layer was coated to a thickness of 0.5 micrometer and dried. A seven-stage calender comprised entirely of metal rolls was used to conduct surface smoothing at a temperature of 90° C. The product was then slit to a width of 12.65 mm to produce a tape.

### Example 2

### Comparative Example 6

With the exception that the calendering temperature was changed to the temperature indicated in Table 1, a magnetic tape was obtained by the same method as in Example 2.

### Comparative Example 7

With the exception that the calendering temperature was changed to the temperature indicated in Table 1, a magnetic tape was obtained by the same method as in Example 1.

### Comparative Example 8

With the exception that the lubricant in the nonmagnetic layer and the magnetic layer coating liquid was changed as indicated in Table 1, a magnetic tape was obtained by the same method as in Example 1.

### Comparative Example 9

With the exception that the lubricant in the nonmagnetic layer and the magnetic layer coating liquid was changed as indicated in Table 1, a magnetic tape was obtained by the same method as in Example 1.

### Comparative Example 10

With the exceptions that the ferromagnetic metal powder having the mean major axis length shown in Table 1 was employed in the magnetic layer coating liquid, the polyurethane resin employed in the magnetic layer coating liquid was changed to that indicated in Table 1, and the calendering temperature was changed to the temperature indicated in Table 1, a magnetic tape was obtained by the same method as in Example 1.

### Comparative Example 11

With the exceptions that the polyurethane resin employed in the magnetic layer coating liquid was changed to that shown in Table 1 and the type and quantity of lubricant added to the nonmagnetic layer and the magnetic layer coating liquid were changed as shown in Table 1, a magnetic tape was obtained by the same method as in Comparative Example 10.

With the exception that the polyurethane resin in the magnetic layer coating liquid was changed to that shown in Table 1, a magnetic tape was obtained by the same method as in Example 1.

### Example 3

With the exceptions that the type and quantity of lubricant added to the nonmagnetic layer and the magnetic layer coating liquid were changed as indicated in Table 1, and the calendering temperature was changed to the temperature shown in Table 1, a magnetic tape was obtained by the same method as in Example 1.

### Comparative Example 1

With the exception that magnetic layer coating liquid B was employed as the magnetic layer coating liquid and the lubricant contained in the nonmagnetic layer coating liquid was changed as shown in Table 1, a magnetic tape was obtained by the same method as in Example 1.

### Comparative Example 2

With the exceptions that the polyurethane resin in the magnetic layer coating liquid was changed to that shown in Table 1 and the type and quantity of lubricant added to the nonmagnetic layer and the magnetic layer coating liquid were changed as shown in Table 1, a magnetic tape was obtained by the same method as in Example 1.

### Comparative Example 3

With the exception that the polyurethane resin in the magnetic layer coating liquid was changed to that shown in Table 1, a magnetic tape was obtained by the same method as in Example 1.

### Comparative Example 4

With the exception that the type and quantity of lubricant added to the nonmagnetic layer and the magnetic layer coating liquid were changed as shown in Table 1, a magnetic tape was obtained by the same method as in Example 1.

### Comparative Example 5

With the exception that the type and quantity of lubricant added to the nonmagnetic layer and the magnetic layer coating liquid were changed as shown in Table 1, a magnetic tape was obtained by the same method as in Example 1.

### Comparative Example 12

With the exceptions that the polyurethane resin employed in the magnetic layer coating liquid was changed to that shown in Table 1 and the calendering temperature was changed to the temperature indicated in Table 1, a magnetic tape was obtained by the same method as in Example 1.

### Example 4

The nonmagnetic layer coating liquid obtained was coated to a support 5 micrometer in thickness with a average center surface roughness of 3.8 nm in a quantity calculated to produce a nonmagnetic layer with a thickness of 1.2 micrometers upon drying, and dried. Thereover, magnetic layer coating liquid C was coated in a quantity calculated to produce a magnetic layer 0.1 micrometer in thickness, and dried. Subsequently, a backcoat layer was coated to a thickness of 0.5 micrometer and dried. A seven-stage calender comprised entirely of metal rolls was used to conduct surface smoothing at a temperature of 90° C. The product was then slit to a width of 12.65 mm to produce a tape.

### Example 5

With the exceptions that the polyurethane resin employed in the magnetic layer coating liquid was changed to that shown in Table 1 and the lubricant employed in the nonmagnetic layer and magnetic layer coating liquid was changed as shown in Table 1, a magnetic tape was obtained by the same method as in Example 4.

### Comparative Example 13

With the exception that the polyurethane resin employed in the magnetic layer coating liquid was changed to that indicated in Table 1, a magnetic tape was obtained by the same method as in Example 4.

### Comparative Example 14

With the exception that the type and quantity of lubricant in the nonmagnetic layer and magnetic layer coating liquid were changed as indicated in Table 1, a magnetic tape was obtained by the same method as in Example 1.

### Comparative Example 15

With the exceptions that the polyurethane resin employed in the magnetic layer coating liquid was changed to that indicated in Table 1 and the calendering temperature was changed to the temperature indicated in Table 1, a magnetic tape was obtained by the same method as in Example 4.

### Evaluation Methods

1. Electromagnetic Characteristics

Electromagnetic characteristics were measured under the following conditions with a reel-to-reel tester on which was mounted an MR head:

Relative speed: 2 m/s

Recording track width: 10 micrometers

Reproduction track width: 5 micrometers

Distance between shields: 0.27 micrometer

Recording signal generator: 8118A made by Hewlett-Packard Co.

Reproduction signal processing: Spectrum analyzer

Linear recording density 160 kfci

The S/N ratio of Comparative Example 3 was adopted as 0 dB. Values equal to or greater than 0 dB were deemed good.

2. Evaluation of High-Speed Running Durability (Increased Frictional Force)

Evaluation was conducted by running a tape under the following conditions with a reel-to-reel tester on which was mounted an MR head disassembled from an LTO-G3 drive made by Hewlett-Packard Co.:

Relative speed: 6.2 m/s

Lap angle: 8.5°

Tension: 100 g

Running frequency: 2,000 passes back and forth

Running length: 40 m

Running environment: 40° C., 80 percent RH

A determination of good high-speed running capability was made when the tension at running pass 2,000 was equal to or less than 45 g.

3. Measurement of Static Frictional Force Following Running

The tape that had been run in 2. above was sampled and measured under the following conditions with a head that had been removed from an LTO-G3 drive made by Hewlett-Packard Co. and mounted on an IEC-type friction tester.

Relative speed: 14 mm/s

Lap angle: 5°

Load: 100 g

After mounting the tape, it was left standing for an hour prior to testing. The initial tension during the first pass was read (running environment: 40° C., 80 percent RH). A tension of equal to or less than 160 g can result in a determination that renewed running was possible without the occurrence of running failure due to sticking of the tape to the head.

4. Measurement of the Number of Protrusions on the Magnetic Layer

An SPA500 atomic force microscope (AFM) made by Seiko Instruments was employed. A 40×40 micrometer area of the magnetic layer surface was scanned in contact mode to determine the number of protrusions equal to or greater than 10 nm in height.

The results are given in Tables 1 and 2.

TABLE 1

| | | | Type of | |
|---|---|---|---|---|
| | | Magnetic | polyurethane in | Calendering |
| | | material | the magnetic | temperature |
| | | size^{Note)} | layer | (° C.) |
| Example | 1 | 45 nm | A | 95 |
| | 2 | 45 nm | C | 95 |
| | 3 | 45 nm | A | 90 |
| Comparative | 1 | 50 nm | — | 90 |
| Example | 2 | 45 nm | D | 95 |
| | 3 | 45 nm | B | 95 |
| | 4 | 45 nm | A | 95 |
| | 5 | 45 nm | A | 95 |
| | 6 | 45 nm | C | 100 |
| | 7 | 45 nm | B | 80 |
| | 8 | 45 nm | A | 95 |
| | 9 | 45 nm | A | 95 |
| | 10 | 35 nm | E | 100 |
| | 11 | 35 nm | C | 100 |
| | 12 | 45 nm | A | 100 |
| Example | 4 | 25 nm | A | 95 |
| | 5 | 25 nm | C | 95 |
| Comparative | 13 | 25 nm | B | 95 |
| Example | 14 | 25 m, | A | 95 |
| | 15 | 25 nm | C | 100 |

| | | Lubricant | | |
|---|---|---|---|---|
| | | | Quantity added to the magnetic | |
| | | | layer/Quantity added to the | |
| | | Type | nonmagnetic layer | |
| Example | 1 | Carbonic ester A | 1 part/ | 1 part |
| | 2 | Carbonic ester A | 1 part/ | 1 part |
| | 3 | Carbonic ester B | 1.5 parts/ | 1.5 parts |
| Comparative | 1 | Butyl stearate | 1.5 parts/ | 1 part |
| Example | 2 | Carbonic ester A | 1.5 parts/ | 1.5 parts |
| | 3 | Carbonic ester A | 1 part/ | 1 part |
| | 4 | Butyl stearate | 1.5 parts/ | 1.5 parts |
| | 5 | Butyl stearate | 0.5 part/ | 0.5 part |
| | 6 | Carbonic ester A | 1 part/ | 1 part |
| | 7 | Carbonic ester A | 1 part/ | 1 part |
| | 8 | Carbonic ester C | 1 part/ | 1 part |
| | 9 | Carbonic ester D | 1 part/ | 1 part |
| | 10 | Carbonic ester A | 1 part/ | 1 part |
| | 11 | Butyl stearate | 1 part/ | 1 part |
| | 12 | Dioleyl carbonate | 1 part/ | 1 part |
| Example | 4 | Carbonic ester A | 1 part/ | 1 part |
| | 5 | Carbonic ester B | 1 part/ | 1 part |
| Comparative | 13 | Carbonic ester A | 1 part/ | 1 part |
| Example | 14 | Butyl stearate | 1.5 parts/ | 1.5 parts |
| | 15 | Carbonic ester A | 1 part/ | 1 part |

^{Note)}mean major axis length for ferromagnetic metal powder, mean plate
diameter for hexagonal ferrite powder

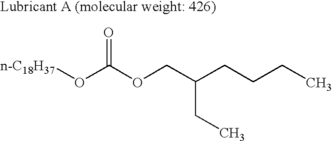

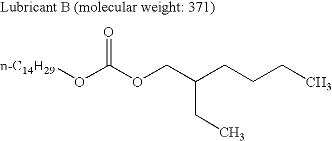

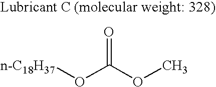

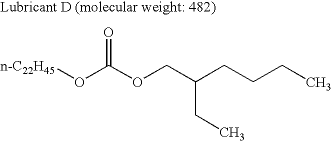

TABLE 2

| | | Magnetic layer | Electromagnetic | Increased | Static frictional force |
|---|---|---|---|---|---|
| | | protrusions | characteristics | frictional force | during renewed running |
| Example | 1 | 258 | 1.5 | 39 g | 135 g |
| | 2 | 66 | 2.1 | 42 g | 140 g |
| | 3 | 482 | 0.3 | 38 g | 136 g |
| Comparative | 1 | 360 | 0.2 | 37 g | 170 g |
| Example | 2 | 79 | 2.5 | 48 g | 148 g |
| | 3 | 420 | 0 | 47 g | 135 g |
| | 4 | 104 | 1.3 | 44 g | 175 g |
| | 5 | 391 | 0.7 | 49 g | 129 g |
| | 6 | 47 | 2.8 | 55 g | 150 g |
| | 7 | 539 | −2.3 | 35 g | 125 g |
| | 8 | 289 | 1.5 | 40 g | 173 g |
| | 9 | 343 | 1.0 | 50 g | 177 g |
| | 10 | 748 | −3.5 | 36 g | 125 g |
| | 11 | 135 | 0.7 | 38 g | 180 g |
| | 12 | 284 | 1.4 | 51 g | 139 g |
| Example | 4 | 117 | 3.2 | 41 g | 138 g |
| | 5 | 55 | 3.6 | 44 g | 146 g |
| Comparative | 13 | 163 | 2.9 | 50 g | 149 g |
| Example | 14 | 141 | 3.0 | 39 g | 182 g |
| | 15 | 10 | 4.1 | Sticking during | — |
| | | | | running | |

Polyurethane Employed
A: Polyurethane obtained by polymerizing 40 weight percent of polyether polyol, 40 weight percent of short-chain diol, and an organic diisocyanate. The short-chain diol had a bridged hydrocarbon structure (see below). The weight average molecular weight was 124,000.

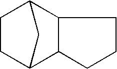

B: Polyurethane obtained by polymerizing 40 weight percent of polyether polyol, 40 weight percent of a short-chain diol having a cyclic structure, and an organic diisocyanate. The weight average molecular weight was 59,000.
C: Polyurethane resin obtained by reacting polyester polyol, a chain-extending agent, and an organic diisocyanate. The polyester polyol comprised an aliphatic dibasic acid and an aliphatic diol comprising a branched alkyl side chain but not having a cyclic structure. The chain-extending agent was an aliphatic diol having a branched alkyl side chain with 3 carbon atoms. The weight average molecular weight was 130,000.
D: Polyurethane resin obtained by reacting polyester polyol, a chain-extending agent, and an organic diisocyanate. The polyester polyol comprised an aliphatic dibasic acid and an aliphatic diol comprising a branched alkyl side chain but not having a cyclic structure. The chain-extending agent was an aliphatic diol having a branched alkyl side chain with 4 carbon atoms. The weight average molecular weight was 64,000.
E: Polyurethane resin obtained by reacting polyester polyol, a chain-extending agent, and an organic diisocyanate. The polyester polyol comprised an aliphatic dibasic acid and an aliphatic diol comprising a branched alkyl side chain but not having a cyclic structure. The chain-extending agent was an aliphatic diol having a branched alkyl side chain with 3 carbon atoms. The weight average molecular weight was 226,000.

The above weight average molecular weights were obtained by standard polystyrene conversion in DMF solvent.

Evaluation Results

Examples 1 to 5 exhibited good electromagnetic characteristics, repeat running property, and renewed running property.

By contrast, Comparative Examples 1, 4, 5, 11, and 14, in which butyl stearate was employed as lubricant, exhibited a large increase in the frictional coefficient during renewed running. This was attributed to sticking between tape and head during storage with the tape and head in contact.

Comparative Examples 2, 3, and 13, in which polyurethane resin having a weight average molecular weight of less than 100,000 was employed as binder, exhibited diminished repeat running property. This was attributed to substantial migration of lower molecular weight binder components to the magnetic layer surface.

Comparative Examples 6 and 15, in which the number of protrusions of equal to or greater than 10 nm on the magnetic layer surface was less than 47/1,600 micrometer², exhibited poor repeat running property due to the high degree of smoothness of the magnetic layer. In Comparative Example 15, in particular, sticking occurred during running and the frictional coefficient could not be measured.

Comparative Example 7 had an excessively rough magnetic layer surface, resulting in substantially diminished electromagnetic characteristics.

In Comparative Example 8, due to the use of low molecular weight carbonic ester, large amounts of the carbonic ester seeped onto the surface of the magnetic layer during storage, compromising renewed running property. In Comparative Example 9, due to the use of high molecular weight carbonic ester, large amounts of precipitate formed during running and storage, compromising the repeat running and renewed running properties. In Comparative Example 12, in which high molecular weight carbonic ester (dioleyl carbonate) was employed, repeat running property also decreased.

In Comparative Example 10, in which polyurethane resin having a weight average molecular weight exceeding 200,000 was employed, the surface smoothness of the magnetic layer decreased and electromagnetic characteristics deteriorated.

The magnetic recording medium of the present invention is suited to use in magnetic recording media for high-density recording in which storage property and stable running over long periods are required, such as backup tapes.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A magnetic recording medium comprising a magnetic layer comprising a ferromagnetic powder and a binder on a nonmagnetic support, wherein
a number of protrusions equal to or greater than 10 nm in height on the magnetic layer surface, as measured by an atomic force microscope, ranges from 50 to 500/1,600 μm²,
the binder comprises a polyurethane resin with a weight average molecular weight ranging from 100,000 to 200,000, and
the magnetic layer further comprises a carbonic ester having a molecular weight ranging from 360 to 460.

2. The magnetic recording medium according to claim 1, wherein the carbonic ester is a carbonic ester denoted by general formula (1). 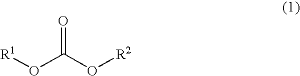
[In general formula (1), R¹ and R² each independently denote a saturated hydrocarbon group.]

3. The magnetic recording medium according to claim 1, wherein one of R¹ and R² denotes a saturated hydrocarbon group having a branched structure.

4. The magnetic recording medium according to claim 1, wherein, among R¹ and R², one denotes a saturated hydrocarbon group having a branched structure and the other denotes a saturated hydrocarbon group having a linear structure.

5. The magnetic recording medium according to claim 3, wherein the branched structure is present at a β position in the saturated hydrocarbon group.

6. The magnetic recording medium according to claim 1, wherein one of R¹ and R² denotes 2-methylpropyl group, 2-methylbutyl group or 2-ethylhexyl group.

7. The magnetic recording medium according to claim 1, wherein the polyurethane resin comprises the following polyurethane resin (A) and/or the following polyurethane resin (B).
Polyurethane resin (A): A polyurethane resin with a weight average molecular weight ranging from 100,000 to 200,000 in the form of a reaction product of a polyether polyol; a short-chain diol having a bridged hydrocarbon structure denoted by the following (a) and/or a bridged hydrocarbon structure denoted by the following (b); and an organic diisocyanate. 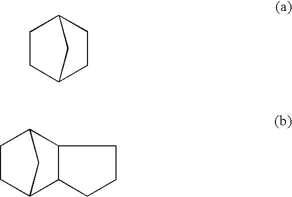
Polyurethane resin (B): A polyurethane resin with a weight average molecular weight ranging from 100,000 to 200,000 in the form of a reaction product of a polyester polyol having a weight average molecular weight ranging from 100,000 to 200,000, comprising an aliphatic dibasic acid and an aliphatic diol not having a cyclic structure but comprising a branched alkyl side chain; an aliphatic diol having a branched alkyl side chain with a total carbon number of equal to or more than 3; and an organic diisocyanate.
